(19) United States
(12) Patent Application Publication
(10) Pub. No.: US 2004/0036768 A1
(43) Pub. Date: Feb. 26, 2004

(54) System and method for electronically viewing behind a vehicle

(76) Inventor: L. Derek Green, Morgan, UT (US)

Correspondence Address: Steve M. Perry, THORPE NORTH & WESTERN, LLP, P.O. Box 1219, Sandy, UT, 84091-1219, US

(21) Appl. No.: 10/465,358

(22) Filed: Jun. 19, 2003

Related U.S. Application Data
(60) Provisional application No. 60/390,409, filed on Jun. 19, 2002.

(51) Int. Cl. H04N 7/18; H04N 9/47

(52) U.S. Cl. 348/148

(57) ABSTRACT

A system and method is provided for electronically viewing behind a vehicle. Included in the invention is the step of coupling a camera to a vehicular mounting unit. The camera is coupled to the vehicular mounting unit so that a plane defined by a boundary of an angle of view of the camera is substantially parallel to a plane defined by a mounting surface of the vehicular mounting unit. The vehicular mounting unit can be affixed to a rear panel of a vehicle in a manner that allows the camera to capture a video image of an area that substantially spans at least a width of the vehicle in an area immediately behind a back portion of the vehicle. The present invention also includes the step of transmitting the video image to a video display that is viewable by a driver of the vehicle.

This application claims priority to U.S. Provisional Patent application No. 60/390,409 filed on Jun. 19, 2002.

### FIELD OF THE INVENTION

The present invention relates generally to electronically viewing behind a vehicle with an electronic imaging device.

### BACKGROUND OF THE INVENTION

Backing up a motorized vehicle can be a frustrating and dangerous task. The dangers associated with backing up a motorized vehicle are largely the result of the driver's inability to see objects or children in the area directly behind the vehicle. This area behind the vehicle that the driver cannot see is called a blind spot. The larger the vehicle is, the bigger this blind spot will be. The blind spot behind the vehicle can hide a child, valuable property, another vehicle, or an animal. Even if the driver is skilled and cautious, property damage and even injury or death to others can result from not being able to see what lies immediately behind the vehicle.

The blind spot behind the vehicle also makes it difficult for a driver to judge the distance from the back of the vehicle to another vehicle, a trailer, or an obstacle. The process of coupling a trailer to either a bumper, fifth wheel or gooseneck hitch is a tedious process which often entails the assistance of a second party. If a second party is not available, the driver may have to leave the vehicle, view the progress, and reenter the vehicle in the attempt to couple the trailer and the vehicle at the hitch. This process can be time consuming and frustrating. Parallel parking is also difficult without an accurate view of exactly how close the back of a driver's vehicle is to another vehicle.

Several solutions have been developed to address these problems. Some cars are outfitted with additional mirrors, but on many vehicles it is difficult to attach enough mirrors to allow the driver to see everything behind the vehicle. Using a system with several mirrors can also be problematic because mirrors often provide a skewed image and a distorted perspective.

Other solutions provide a camera that attaches to the back of the vehicle. The camera sends video data to a monitor in the cab of the vehicle so the driver can see the area behind the vehicle that the camera is monitoring. These camera systems are an improvement over just using mirrors, but the cameras do not capture significant portions of the blind spot behind the vehicle, which leaves regions that the driver still cannot see. As shown in FIG. 1, the camera 14 can be mounted on the back of the vehicle 12 to capture images within the camera's angle of view boundaries 20. The area captured by the camera does not include side portions of the blind spot 16. FIG. 2 shows a side view of a vehicle 102 with a camera 106 mounted on the back. The area within the camera's angle of view boundaries 104 does not capture the area immediately underneath the camera 108.

Cameras can also be affixed to vehicles near a hitch to help a driver couple the hitch to a trailer. However, in this configuration the image from the camera can be difficult to interpret because the image only offers an orthogonal view of an area behind the vehicle.

### SUMMARY OF THE INVENTION

The present invention provides a system and method for electronically viewing behind a vehicle. Included in the invention is the step of coupling a camera to a vehicular mounting unit. The camera is coupled to the vehicular mounting unit so that a plane defined by a boundary of an angle of view of the camera is substantially parallel to a plane defined by a mounting surface of the vehicular mounting unit. The vehicular mounting unit can be affixed to a rear panel of a vehicle in a manner that allows the camera to capture a video image of an area that substantially spans at least a width of the vehicle in an area immediately behind a lower back portion of the vehicle. The present invention also includes the step of transmitting the video image to a video display that is viewable by a driver of the vehicle.

### BRIEF DESCRIPTION OF THE DRAWINGS

FIG. 1 is a top view of an angle of view captured by a prior art solution;

FIG. 2 is a side view of an angle of view captured by a prior art solution;

FIG. 3 is a flow chart of an embodiment of the present invention for electronically viewing behind a vehicle;

FIG. 4 is a flow chart of another embodiment of the present invention for electronically viewing behind a vehicle;

FIG. 5 is an expanded view of an electronic imaging device according to an embodiment of the invention;

FIG. 6 is a diagram of an electronic imaging device according to an embodiment of the present invention;

FIG. 7 is a cross sectional view of a vehicle with an electronic imaging device for viewing behind a vehicle;

FIG. 8 is a top view of an angle of view captured by an embodiment of the present invention; and

FIG. 9 is a side view of an angle of view captured by an embodiment of the present invention.

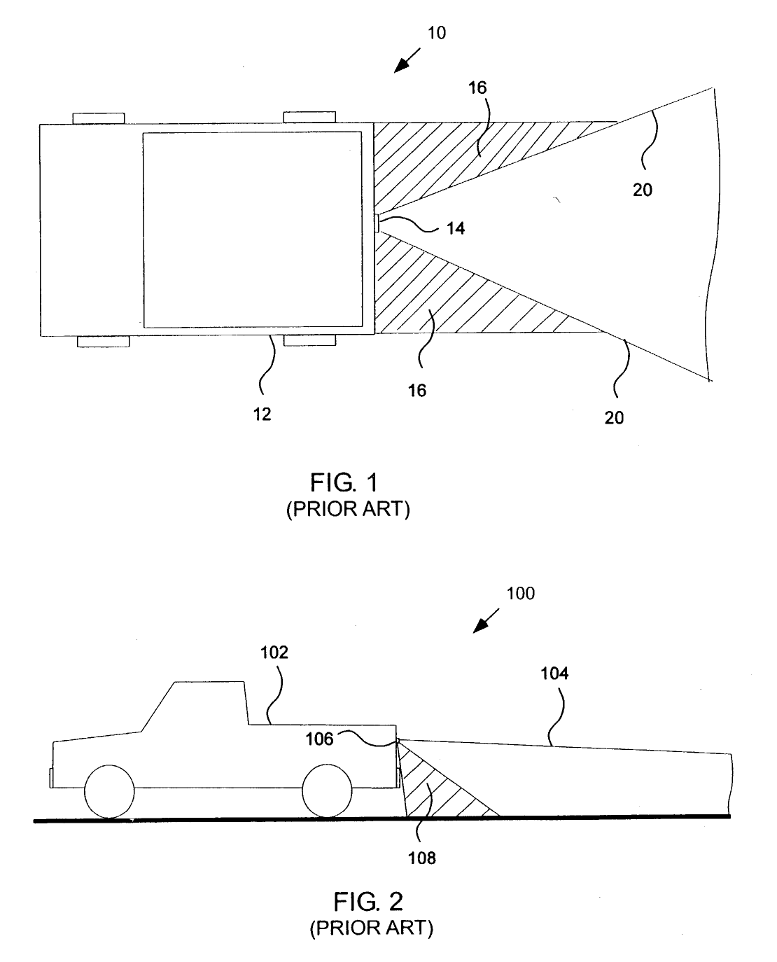

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

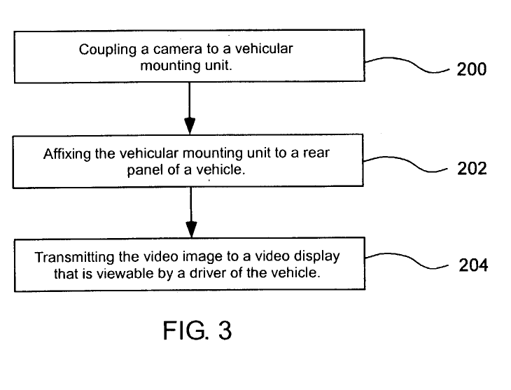

The present invention provides a system and method for electronically viewing behind a vehicle in a manner that allows a driver of the vehicle to see the blind spot behind the vehicle. FIG. 3 shows that this can be accomplished by coupling a camera to a vehicular mounting unit, as illustrated in block 200. The camera can be any type of electronic image capture device. The vehicular mounting unit can be fixed or movable, and can be mounted either internally or externally. Both the camera and the vehicular mounting unit can be weather resistant.

The vehicular mounting unit has a back mounting surface that comes into contact with a rear panel of a vehicle when the mounting unit is affixed to the vehicle. This back mounting surface defines a plane that is substantially parallel to a plane defined by the back mounting surface of the vehicle.

The boundary of an area captured by the camera is defined by an angle of view of the camera. A portion of the boundary of the angle of view of the camera is substantially parallel to the plane defined by the back mounting surface of the vehicular mounting unit. This means that the camera captures images that are substantially directly underneath the camera.

The vehicular mounting unit is affixed to the rear panel of a vehicle 202 in a manner that allows the camera to capture a video image of an area that substantially spans at least a width of the vehicle in an area immediately behind a back portion of the vehicle. The back portion of the vehicle can be the area around a bumper, the tail gate area of a truck, or any other back portion of the vehicle. Once the camera is in place, the camera can begin transmitting the video image to a video display that is viewable by a driver of the vehicle 204.

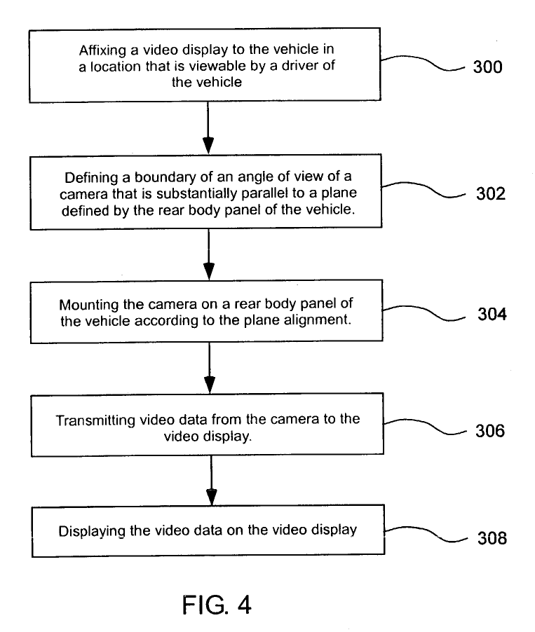

Another embodiment of the invention for electronically viewing behind a vehicle is shown in FIG. 4. Block 300 illustrates that a video display is affixed to the vehicle in a location that is viewable by a driver of the vehicle. The video display can also include a separate processing unit for receiving and processing video data from a camera. According to one embodiment of the present invention, the camera is mounted so that the image captured by the camera includes the region directly under the camera and behind the car. In other words, a boundary of the camera's angle of view is defined as being substantially parallel to a plane defined by the rear body panel 302. The camera is mounted on a rear body panel of the vehicle according to an alignment of the boundary of the camera's angle of view and the plane defined by the rear body panel.

When the camera is mounted, the video data is transmitted from the camera to the video display 306. The video data can then be displayed on the video display so that a viewable image of the video display shows a region defined by the boundary of the angle of view of the camera 308. In this configuration, the video display can display the entire area captured by the camera or a portion of the area captured by the camera. The driver of the vehicle can see this video data and react to avoid obstacles and navigate the vehicle backwards.

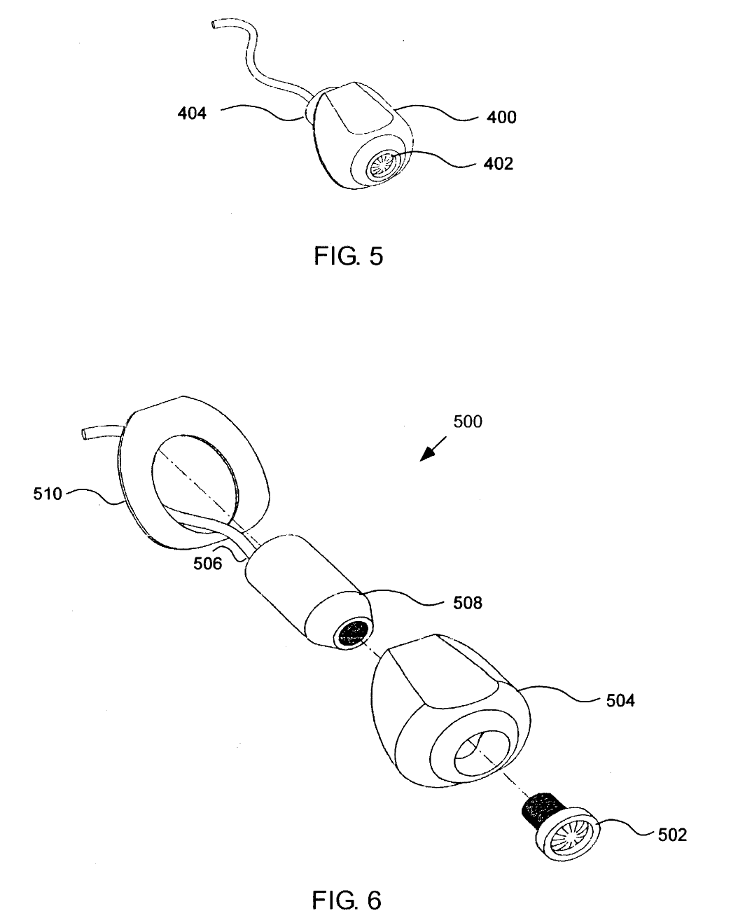

FIG. 5 and FIG. 6 show the composition of the camera. The camera comprises a camera body 404, 508 and a lens 402, 502. The lens can be a wide angle lens. The camera body is attached to a mounting base 400, 504 that holds the camera. The mounting base can be configured to mount to the vehicle externally or internally, and a mounting angle of the mounting base points in a downward direction 510. A gasket 504 can also be used to seal the camera to the back panel of the vehicle. Adhesives or other methods for affixing the mounting base to the back panel of the vehicle can be used to attach the mounting base to the vehicle.

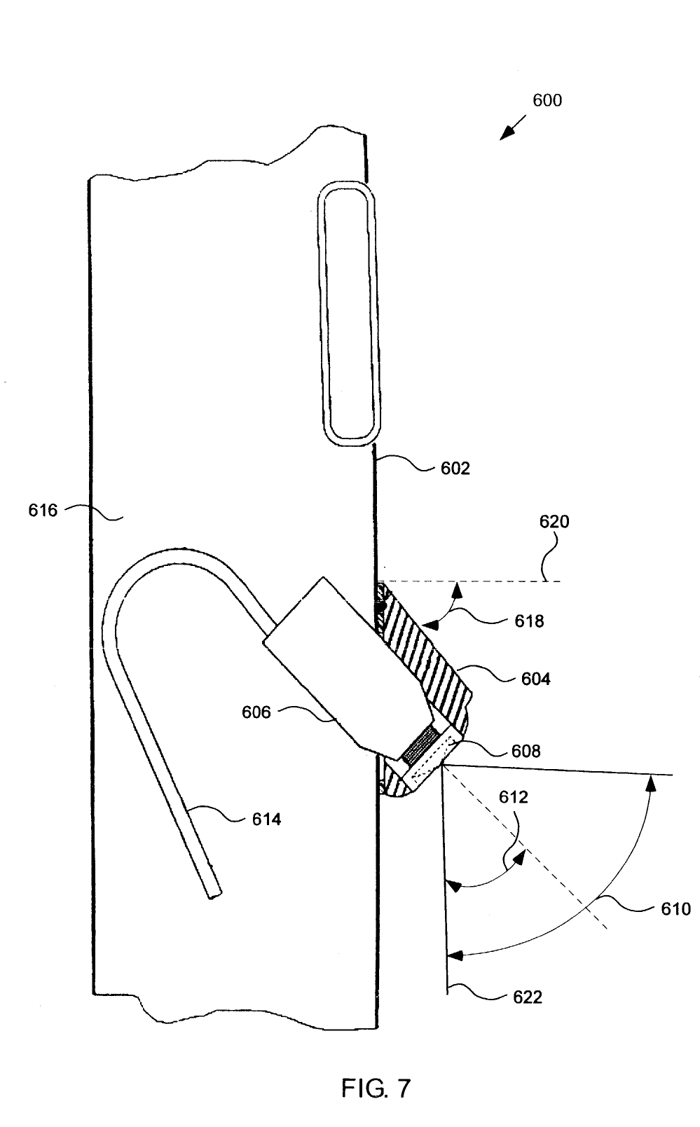

The manner in which the camera is affixed to vehicle is illustrated in FIG. 7. The camera can be mounted in or on a rear body panel 602 of a vehicle. The rear body panel includes locations such as the tailgate of a pickup truck, back portion of a trunk lid of an automobile, the rear facing roof line panel of a pickup for a gooseneck or fifth wheel, or other similar locations. The mounting base 604 is attached to the rear body panel of the vehicle and holds the camera at a mounting angle 618. This mounting angle is measured from a plane perpendicular to a plane defined by the rear body of the vehicle, as shown by the dotted line 620. The camera can be mounted externally, internally, or where at least a portion of the camera body is in an internal cavity 616 of the rear body panel of the vehicle. The advantage of mounting the camera with a portion of the camera body in an internal cavity of the rear body panel is that the lens can be closer to the back of the vehicle. The closer the lens is to the back of the vehicle, the more area behind the vehicle the camera can capture.

The camera is set in the mounting base 604, and the camera comprises a mounting base 606 and a lens 608. The lens has a fixed angle of view 610 and is affixed to the camera body 606. The angle of view of a camera is derived from a focal length of the lens. The angle is formed by imaginary lines or boundaries projected from the center of the lens and indicates how much of the subject will be included in the frame. One half of the angle of view 612 refers to the angle from the center of the lens to the boundary of the angle of view. According to the present invention, the sum of the mounting angle and of one half the fixed angle of view is substantially 90 degrees. According to one embodiment of the present invention, the angle is at least 80 degrees.

A display screen can be affixed to the vehicle in a location that is viewable by a driver of the vehicle. The display screen shows images captured by the camera lens. This video data from the camera can be received in a video processor, and the video processor sends the processed video data to the screen. The processor can be integrated into the screen or installed as a separate physical component. The display screen can be mounted in a manner that allows omni-directional rotation, bi-directional rotation, uni-directional rotation, no rotation, or the display screen can be mounted in any other configuration. The screen can be mounted to the windshield, the overhead console, or another location viewable by the driver. The display can also be incorporated into a rearview mirror. When this is the case, a function for switching between the rearview mirror and the camera display can be implemented.

The display screen can be an LCD display, an LED display, or any other display screen for showing video images. The display screen can also include input ports for television signals, multiple cameras, or other similar electronic signals. The connection that couples the camera to the display screen can be a wireless connection or a hardwired connection. If the connection is a wireless connection, the camera will be coupled to a transmitter and the video display will be coupled to a receiver. The receiver can be installed near the video processor or near the display screen, or can be integrated into the video processor or the display screen.

The mounting base can be configured to allow the camera to rotate. The camera can be rotated manually or with small motors. When small motors are used, a remote control device for controlling the camera is provided to the driver. This control device can be hardwired to the motor or motors that move the camera, or the connection between the control device and the motor or motors can be wireless. The controls can be mounted in the dashboard or other location inside or outside of the vehicle, or the controls can be in an independent remote controlling device.

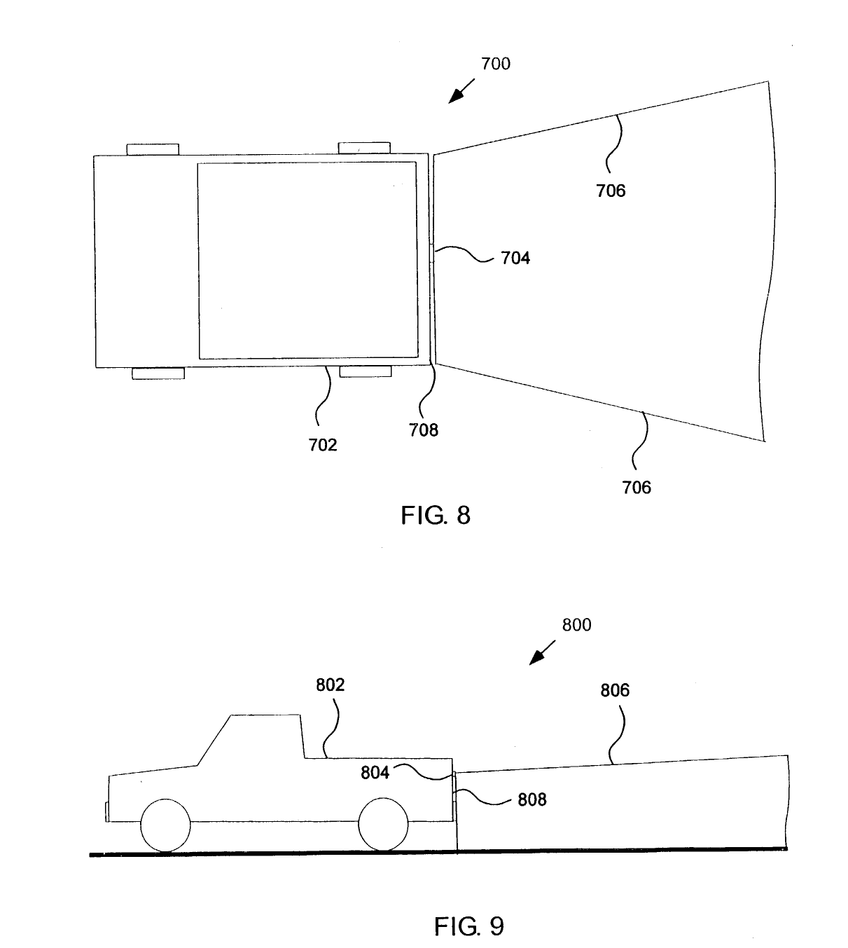

A top view and a side view of the system for electronically viewing behind a vehicle is shown in FIG. 8 and FIG. 9, respectively. The vehicle 702, 802 has an imaging device 704, 804 affixed to a back panel 708, 808. The imaging device is affixed in a manner that allows a lens of the imaging device to capture a video image of an area that substantially spans at least a width of the vehicle in an area immediately behind a lower back portion of the vehicle. This area is outlined as area 706, 806. As shown in the drawings, this area covers the blind spots immediately behind the vehicle along the entire length of the vehicle, and the blind spot directly underneath the camera. Any object, person, or other vehicle behind the vehicle will be captured in a image that is sent to a display device. The driver can view these images and avoid collision with the object, person, or other vehicle.

The device can also capture a trailer or other vehicle at some distance behind the vehicle. This distance is at least a vehicle length, and can even extend to the horizon. This provides ease in coupling the vehicle to a trailer and helps the driver avoid obstacles that are located some distance behind the vehicle. Because the imaging device is angled in a downward direction, the imaging device captures a perspective view of a trailer hitch or other obstacle. The perspective view of the region behind the vehicle provides the driver with a greater depth perception than a orthogonal view of the region behind the vehicle.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiments(s) of the invention. It will be apparent to those of ordinary skill in the art that numerous modifications can be made without departing from the principles and concepts of the invention as set forth in the claims.

What is claimed is:

1. A method for electronically viewing behind a vehicle, comprising the steps of:
coupling a camera to a vehicular mounting unit, wherein a plane defined by a boundary of an angle of view of the camera is substantially parallel to a plane defined by a mounting surface of the vehicular mounting unit; and
affixing the vehicular mounting unit to a rear panel of a vehicle in a manner that allows the camera to capture a video image of an area that substantially spans at least a width of the vehicle in an area immediately behind a back portion of the vehicle; and
transmitting the video image to a video display that is viewable by a driver of the vehicle.

2. The method for electronically viewing behind a vehicle as in claim 1, wherein the step of coupling a camera to a vehicular mounting unit further comprises the step of coupling a camera with a wide angle lens to a vehicular mounting unit.

3. An electronic imaging device for viewing behind a vehicle, comprising:
a camera body;
a mounting base configured for attachment to a rear body panel of the vehicle and configured to hold the camera body at a mounting angle, wherein the mounting angle is measured from a plane perpendicular to a plane defined by the rear body panel of the vehicle;
a camera having a fixed angle of view and affixed to the camera body, wherein a sum of the mounting angle and of one half the fixed angle of view of the camera is substantially 90 degrees; and
a display screen affixed to the vehicle in a location that is viewable by a driver of the vehicle, wherein the display screen shows images captured by the camera lens.

4. The electronic imaging device for viewing behind a vehicle as in claim 3, further comprising a wireless connection that couples the camera body to the display screen.

5. The electronic imaging device for viewing behind a vehicle as in claim 3, further comprising a hardwired connection that couples the camera to the display screen.

6. A method for electronically viewing behind a vehicle, comprising the steps of:
affixing a video display to the vehicle in a location that is viewable by a driver of the vehicle;
defining a boundary of an angle of view of a camera equal to a plane that is substantially parallel to the rear body panel of the vehicle;
mounting the camera on a rear body panel of the vehicle according to an alignment of the angle of view of the camera and the plane that is substantially parallel to the rear body panel of the vehicle;
transmitting video data from the camera to the video display; and
displaying the video data on the video display, wherein a viewable image of the video display shows a region defined by the boundary of the angle of view of the camera.

7. The method for providing electronic vision behind a vehicle as in claim 6, wherein the step of transmitting video data further comprises the step of transmitting video data using a wireless connection.

8. The method for providing electronic vision behind a vehicle as in claim 6, wherein the step of transmitting video data further comprises the step of transmitting video data over a hardwired connection.

9. The method for providing electronic vision behind a vehicle as in claim 6, wherein the step of attaching a video display to the vehicle further comprises the step of attaching an LCD screen to the vehicle.

10. A method for electronically viewing behind a vehicle, comprising the steps of:
affixing a video display to the vehicle, wherein the video display is viewable by a driver of the vehicle;
mounting a camera in a rear panel of a vehicle, wherein at least a portion of the camera is mounted in an internal cavity of a rear panel of the vehicle;
positioning the camera in a manner that allows the camera to capture images of at least a portion of a rear bumper region of the vehicle; and
displaying video data received from the camera on the video display.
